(19) United States
(12) Patent Application Publication
(10) Pub. No.: US 2003/0234365 A1
(43) Pub. Date: Dec. 25, 2003

(54) Optical detector

(76) Inventor: Jan Wipenmyr, Hisings-Karra (SE)

Correspondence Address: HOWREY SIMON ARNOLD & WHITE LLP, 1299 PENNSYLVANIA AVE., NW, BOX 34, WASHINGTON, DC, 20004, US

(21) Appl. No.: 10/248,344

(22) Filed: Jan. 10, 2003

Related U.S. Application Data
(60) Provisional application No. 60/319,057, filed on Jan. 10, 2002.

(51) Int. Cl. G01J 5/00

(52) U.S. Cl. 250/372

(57) ABSTRACT

Method and arrangement for an optical detector arrangement for detecting and registering incident ultraviolet (UV) radiation and characteristics of a protective agent applied thereon. The arrangement includes at least two sensors each connected to electrical circuitry for generating a detection signal, one of the at least two sensors is arranged as a reference sensor and the other one as a detector sensor to be applied with a protective agent. The electrical circuitry is arranged to compare signals from the reference and indicator sensors and output an signal corresponding to the characteristics of the protective agent.

### CROSS REFERENCE TO RELATED APPLICATIONS

The present application claims the benefit of U.S. Provisional Patent Application No. 60/319,057 filed Jan. 10, 2002.

### BACKGROUND OF INVENTION

1. Technical Field

The present invention relates to an optical detector arrangement for detecting and registering incident ultraviolet (UV) radiation and characteristics of a protective agent applied thereon.

2. Background Information

A sunburn or a tan can be considered attractive at the same time that the exposure to too much ultraviolet radiation may cause skin cancer, such as malignant melanoma, and also early skin aging.

The ultraviolet radiation is generally classified into substantially three different wavelength areas, i.e. ultraviolet radiation, type A (UVA), ultraviolet radiation, type B (UVB) and ultraviolet radiation, type C (UVC). The UVA, and especially the UVB radiation are injurious for the skin, while the UVC radiation hardly hits the surface of the earth at all. The UVA radiation is relatively constant over the entire surface of the earth, while the UVB radiation varies considerably depending on the time of the day, the position on the earth and the thickness of the ozone layer. It should also be appreciated that the ultraviolet radiation of solariums is also mainly of the UVA-type. The UVA radiation substantially comprises wavelengths in the ultraviolet radiation region of about 400-320 nm. The UVB-radiation substantially comprises wavelengths in the ultra violet radiation region of about 320-280 nm. Finally, the UVC-radiation substantially comprises wavelengths in the ultra violet radiation region of about 280-200 nm.

It is, however, possible to protect oneself against ultraviolet radiation with sun control inhibitors or sun cream comprising a sun protection factor (SPC). Unfortunately, the SPC system is only valid for UVB radiation; that is, there is no method of measuring the UVA radiation, but the sun cream in itself does actually protect against both the UVA and UVB radiation. Moreover, the SPC factor, in most investigations, is only calculated for an application amount of SPC being considerably larger than the application amount of SPC that most people use, for instance when sun bathing.

Still further, the SPC degenerates over the course of time. Thus, the protection against UVA-radiation strongly decreases over the course of time for the sun protection creams available on the market. After a day in the sun, the absorbent effect of SPC reduces considerably. The absorption spectra of the SPC are then transferred to the UVC-region, where the SPC is not useful for protecting the user anymore.

Several arrangements have earlier been proposed to measure the ultraviolet radiation of the sun, especially for sun bathing.

U.S. Pat. No. 5,986,273 shows an ultraviolet radiation sensor that includes a thin, transparent semi-permeable membrane and an indicator means. The membrane is adhesive and may be worn on the skin to indicate the exposure of ultraviolet radiation and comprises ink that changes color gradually. This ultraviolet radiator sensor shows the user, such as a sunbather, when the exposure to sunlight should be terminated and/or when additional sunscreen should be applied. Further, this sensor may also be provided with a means to receive and absorb a sun screen preparation such that the user knows when to re-apply additional sun screen. Consequently, the sensor exhibits the absorbent characteristics of the sunscreen preparations on human skin by means of emulating the manner in which the sunscreen is absorbed by the human skin. As the general degeneration by solar radiation increases, the sun screen preparation will slowly become less and less effective in preventing the transmission of ultraviolet through the membrane to the indicator means of the sensor. Eventually, the membrane gradually will change the color to indicate that more sunscreen should be applied. In summary, this ultraviolet radiation sensor is only pre-set to different levels of radiation.

U.S. Pat. No. 4,985,632 shows an electronic watch having a photo diode for detecting skin damaging UVB ultraviolet tanning radiation. Some of the members of the watch interact so that the intensity of the UVB radiation presently incident on the detector gives an instantaneous value of the UVB radiation detected, but this arrangement will not measure the UVA and the UVC radiation. Moreover, the watch also presents the maximum time a user can be safely exposed to the UVB radiation, which is however initially calculated, preferably by a computer. The effect of any sun screening agents is not considered.

U.S. Pat. No. 5,008,548 shows a miniaturized portable battery operated with a combined power and energy radiometer, which provides a means to determine the direction of the maximum radiant UV power and also the measurement of total experienced energy over time, i.e. a received dosage. The miniaturized portable battery produces an alarm upon the attainment of a predetermined dosage level set by the user. Again, the effect of the sun screening agents is not considered.

U.S. Pat. No. 5,365,068 shows a portable device for calculating an optimal safe SPF lotion to be applied by the user under local ambient conditions. The user inputs his or her skin type and the amount of time that he or she wishes to spend in the sun. The device includes a photovoltaic (PV) cell for self-power having a battery back up.

Swedish Patent Application Patent No. 0102226-8, by the same Applicant, shows a UV detection sensor for detecting and registering incident ultraviolet radiation, a protective agent such as a SPC, and the degeneration of the SPC; this patent application is expressly incorporated herein by reference.

### SUMMARY OF INVENTION

The present invention provides an optical detector arrangement for detecting and registering incident ultraviolet radiation, allowing detection of the quality of protective agents.

Accordingly, the optical detector arrangement of the present invention includes at least two sensors, each connected to electrical circuitry for generating a detection signal. One of the two sensors is arranged as a reference sensor and the other of the two sensors is arranged as a detector sensor to be applied with a protective agent. The electrical circuitry is arranged to compare signals from the reference and indicator sensors and to output a signal corresponding to changes in the characteristics of the protective agent. The characteristics include at least one of efficiency or degeneration of said protective agent.

The arrangement also has a covering that covers the sensors. The covering includes filters that have an area that is transparent to ultraviolet radiation allowing its passage therethrough. The filters are arranged to exhibit characteristics similar to human skin with respect to absorbency, transparency, thickness, and the like. The arrangement further quantifies and indicates the amount of ultraviolet radiation. This characteristic is optionally provided as a value of the accumulated total dose of ultraviolet radiation and/or as a real-time value of ultraviolet radiation being experienced.

The sensors can be provided with optical filters so that the incident UV radiation passing through the filters initially hits the optical filters and subsequently hits the sensors. The active elements are photo diodes. The optical filters are arranged for at least one of UVA and UVB radiation. The reference diode is blocked to the incident UV radiation.

The UVA radiation has a wavelength of about 400 to about 320 nm, and the UVB radiation has a wavelength of about 320 to about 280 nm.

The electrical circuitry includes amplifiers, ADC, an integrator, a resetting unit, calculating units an oscillator, a memory unit driving elements and display units. The optical detector arrangement also has data representing different skin types. The protective agent is a sun protective means such as a sun checking inhibitor, sun screen inhibitor, or the like. The efficiency of the protective agent is constituted as a SPC. The sensor is adjustable for different skin types and it can be provided with an alarm unit. Preferably, the sensor is waterproof and the sensor is powered by solar cells.

The presently disclosed invention(s) also relate to a method of detecting and registering incident ultraviolet (UV) radiation and characteristics of a protective agent applied on a detector arrangement. The method includes providing the arrangement with at least two sensors, each connected to electrical circuitry for generating a detection signal. One of the sensors is arranged as a reference sensor and the other as a detector sensor to be applied with the protective agent. The electrical circuitry is also arranged to compare signals from the reference and indicator sensors and output an signal corresponding to characteristics of the involved protective agent.

### BRIEF DESCRIPTION OF DRAWINGS

In the following, the invention will be described in more detail and in a non-limiting way with reference to the accompanying drawings, in which:

FIG. 1 is an exploded perspective view of a preferred embodiment of the present invention;

FIG. 2 shows a schematic cross-sectional view of a UV detector configured according to the invention, including representations of the active elements according to a preferred embodiment of the invention; and

FIG. 3 graphically shows an exemplary wiring diagram of a sensor arranged as shown in FIG. 2.

### DETAILED DESCRIPTION

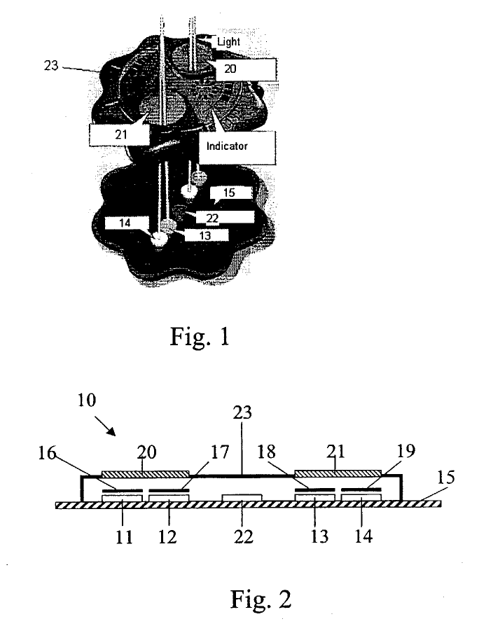

In a preferred embodiment of the invention, as exemplarily illustrated in FIGS. 1 and 2, an optical detector arrangement 10 includes five active elements 11, 12, 13, 14 and 22 that are arranged on a carrier 15 placed under a covering 23. Active elements 11 and 13 are arranged with optical filters 16 and 18, such that the incident ultraviolet radiation passes through the optical filters 16 and 18 and hits the active elements 11 and 13. The optical filters 16 and 18 are intended for UVB radiation and therefore have a bandpass filter for UVB radiation centered around approximately 300 nm and having a full width at half maximum of approximately 30 nm. Active elements 12 and 14 are arranged with optical filters 17 and 19, such that the incident ultraviolet radiation passes through the optical filters 17 and 19 and hits the active elements 12 and 14. The optical filters 17 and 19 are intended for UVA radiation and therefore have a bandpass filter for UVA radiation centered around about 360 nm having a full width at half maximum of approximately 80 nm. The element 22 is a reference diode and is also arranged on the carrier 15.

The UV detection sensor arrangement 10 includes members 20 and 21, which are applicable with a protective agent, such as a sun protective means, sun checking inhibitor or sunscreen. The members 20, 21 are transparent for UV radiation, and consequently serve as a window for the UV radiation. The windows 20 and 21 are arranged in connection with the active elements 11 and 12, and 13 and 14, respectively at locations between the incident ultraviolet radiation and the optical filters 16, 17, 18 and 19. The arrangement is such that the incident ultraviolet radiation passes through the windows 20 and 21, and thereafter hits the optical filters 16, 17, 18 and 19, but not the reference diode 22.

Additionally, the windows 20 and 21 show substantially the same characteristics as human skin, for instance with respect to absorption and transparency of ultraviolet radiation via thickness of the windows 20 and 21, and the like.

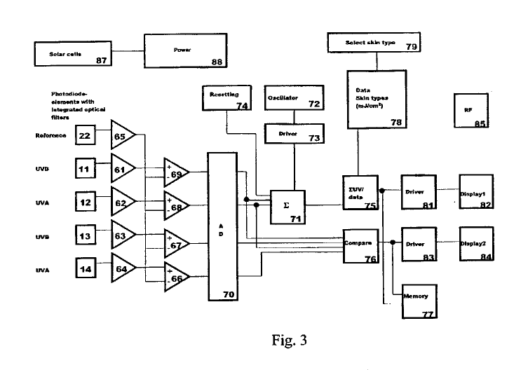

The wiring diagram for an electrical arrangement of an UV detection sensor configured according to FIG. 2 is exemplarily illustrated in FIG. 3. In this embodiment, the active elements 11, 12, 13 and 14 as well as the reference diode 22 are initially connected to signal amplifiers 61, 62, 63, 64 and 65 respectively. Preferably, the active elements 11, 12, 13 and 14 and the reference diode 22 are connected to operation amplifiers 66, 67, 68 and 69. The operational amplifiers 66, 67, 68 and 69 are in turn connected to an ADC 70, which in turn is connected to an integrator 71 and a calculating unit 76.

Except for the operation amplifiers 66, 67, 68 and 69, the signal units connected to the integrator 71 are preferably a driver element 73 and a resetting unit 74. An oscillator is in turn connected to the driver element 73.

Further, the integrator 71 is connected to a calculating unit 75. The calculating unit 75 is connected to a driver element 81, which in turn is connected to a display unit 82. Moreover, a memory unit 78 is connected to the first calculating unit 75. Further, an input unit 79 is connected to the memory unit 78.

Furthermore, the ADC 70 is connected to a second calculating unit 76, which is in the same way as the first calculating unit 75 is connected to a second driver element 83, which in turn in connected to a display unit 84. The calculating units 75 and 76 are also connected to a memory unit 77.

The UV detection sensor 10 is adjustable for different skin types in one embodiment of the invention; that is, the sensor 10 includes the data unit 78 having data representing some different skin types (mJ/cm²), and also the input unit 79 for choosing the required individual skin type with regard to the maximum ultraviolet radiation dose (mJ/cm²). In one alternative embodiment, different UV detector sensor units 10 can be arranged for different skin types with regard to the ultraviolet radiation dose (mJ/cm²).

The UV detection sensor 10 can be arranged with an alarm unit that goes off when the maximum dose of ultraviolet radiation is obtained. The UV detection sensor 10 can also be arranged with a RF unit 85 for wireless communication of stored data with an external computer/display unit.

The UV detection sensor 10 adapted according to the teachings of the present invention operates in the following way. Initially, the UV detection sensor 10 is set for the desired skin type, if necessary. Subsequently, the UV detection sensor 10 is reset. The user, such as a sunbather, applies a protective agent such as suntan lotion to his or her body, as well as to one of the windows 20 of the UV detection sensor 10.

The display unit 82 of the sensor 10, on a substantially instantaneous basis, continuously indicates the total accumulated dose of the UVA and UVB radiation by means of the integrator 71 and the calculating unit 75. This is possible because the measured UVA and UVB radiation of the active elements 11 and 12 is an instantaneous measurement of the accumulated dose of the total UVA and UVB radiation is collected. The total dose of UVA and UVB-radiation is presented compared to the total dose for the actual skin type chosen. However, it is also possible to show the UVA and UVB radiation as a measurement in real-time; that is, it is possible to display how the incoming UV radiation varies in time.

Secondly, the display unit 84 of the sensor 10 substantially instantaneously and continuously indicates the relation between the element 11 (UVB) and element 13 (UVB), respectively with respect to element 12 (UVA) and element 14 (UVA) by means of the calculating unit 76, a relationship that is a measurement of the sun protection factor. In this way, the window 20 that has been applied with a protective agent is compared to the window 21 not applied with the protective agent. The degeneration of the protective agent can also be obtained in this way, as a total value or in real-time.

An alarm signal can be generated when the maximum dose of UVA and UVB radiation is obtained for a chosen skin type. In one embodiment, the alarm unit alarms when a predetermined value of degeneration of SPC is obtained.

The optical detectors arrangement in the preferred embodiment can be arranged as a part of a membrane, a watch, a button, a sticker, or the like that can be worn by an individual such as a sunbather.

The active elements 11, 12, 13, 14 and 22 are UV indicating means such as photo detectors or photo diodes operating in the ultraviolet radiation region. The filters 16, 17, 18, and 19 are preferably optical filters, which substantially only transmit specified wavelengths.

The UV detection sensor 10 is preferably waterproof so that they can be used when swimming, which also can degenerate the sun protection agent.

Appropriate wiring diagrams are not limited to the illustrated examples. The type and connection of components can be varied in many ways, within the knowledge of a skilled person, as long as the function of the circuits are according to the teachings of the invention.

Still further, the invention is not limited to the embodiments shown, but can be varied in a number of different ways, for instance by combination of two or more of the embodiments shown, without departing from the scope of the appended claims, and the arrangement and the method can be implemented in a number of ways depending on application, functional units, needs and requirements and the like.

1. An optical detector arrangement for detecting and registering incident ultraviolet radiation and characteristics of a protective agent applied thereon, the arrangement comprising:
at least two sensors, each connected to electrical circuitry for generating a detection signal, one of said at least two sensors being arranged as a reference sensor and the other one as a detector sensor to be applied with a protective agent; and
said electrical circuitry being arranged to compare signals from said reference and indicator sensors and output a signal corresponding to characteristics of said protective agent.

2. The optical detector arrangement of claim 1, wherein said characteristics include at least one of efficiency and degeneration of said protective agent.

3. The optical detector arrangement of claim 1, said arrangement further comprising a covering for covering said sensors.

4. The optical detector arrangement of claim 3, said covering further comprising members consisting of areas in said covering that are transparent for ultraviolet radiation passing therethrough.

5. The optical detector arrangement of claim 3, wherein said members are arranged to exhibit characteristics similar to human skin with respect to at least one of the aspects including absorbency, transparency, and thickness.

6. The optical detector arrangement of claim 1, wherein said arrangement is configured to provide information on a measured amount of sustained ultraviolet radiation.

7. The optical detector arrangement of claim 1, wherein said characteristics are optionally provided as one of a value of accumulated total dose and a real-time value.

8. The optical detector arrangement of claim 3, said sensors further comprising optical filters arranged so that incident UV radiation passing through the members initially hits the optical filters and subsequently hits the sensors.

9. The optical detector arrangement of claim 1, wherein the active elements are photo diodes.

10. The optical detector arrangement of claim 6, wherein the optical filters are arranged for at least one of UVA and UVB radiation.

11. The optical detector arrangement of claim 1, further comprising a reference diode blocked to the incident UV radiation.

12. The optical detector arrangement of claim 10, wherein said UVA radiation has a wavelength of about 400 to about 320 nm and said UVB radiation has a wavelength of about 320 to about 280 nm.

13. The optical detector arrangement of claim 1, said electrical circuitry further comprising amplifiers, ADC, an integrator, a resetting unit, calculating units, an oscillator, a memory unit driving elements and display units.

14. The optical detector arrangement of claim 1, further comprising being adapted to consider data representing different skin types.

15. The optical detector arrangement of claim 1, wherein the protective agent is a sun protective means.

16. The optical detector arrangement of claim 15, wherein the sun protective means is a sun checking inhibitor.

17. The optical detector arrangement of claim 15, wherein the sun protective means is a sun screening inhibitor.

18. The optical detector arrangement of claim 1, wherein efficiency of the protective agent is constituted of the SPC.

19. The optical detector arrangement of claim 1, wherein the sensor is adjustable for different skin types.

20. The optical detector arrangement of claim 1, further comprising an alarm unit.

21. The optical detector arrangement of claim 1, wherein the sensor is waterproof.

22. The optical detector arrangement of claim 1, wherein the sensor is powered by solar cells.

23. A method of detecting and registering incident ultraviolet (UV) radiation and characteristics of a protective agent applied on a detector arrangement, the method comprising the steps of:
providing said arrangement with at least two sensors, each connected to electrical circuitry for generating a detection signal;
arranging one of said at least two sensors as a reference sensor;
arranging one of said at least two sensors as a detector sensor to be applied with said protective agent;
arranging said electrical circuitry to compare signals from said reference and indicator sensors; and
outputting a signal corresponding to characteristics of said protective agent.
